(19) United States
(12) Patent Application Publication
(10) Pub. No.: US 2008/0270119 A1
(43) Pub. Date: Oct. 30, 2008

(54) Generating sentence variations for automatic summarization

(75) Inventor: Hisami Suzuki, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/799,286

(22) Filed: Apr. 30, 2007

(51) Int. Cl. G06F 17/27

(52) U.S. Cl. 704/9; 704/E15.003

(57) ABSTRACT

A new system is hereby provided that generates automatic summaries of groups of multiple documents using multiple variations of each sentence from a selected group of representative sentences from the documents, and then selecting from the multiple variations when assembling the automatic summary. The system may generate alternative strings of text, select from among the alternative strings of text, and provide a summary of the group of documents using the strings of text selected from among the alternatives. The alternative strings of text may be generated based on each of a plurality of sentences from the group of documents. Selecting from among the alternative strings of text may be based on one or more criteria indicating the strings of text to be representative of the content of the group of documents.

### BACKGROUND

Systems are available that automatically summarize a group of multiple documents. These systems work by extracting a representative subset of sentences out of the documents, and assembling the representative subset together into a summary. These systems may also simplify the original sentences, and then use the simplified versions of the sentences to assemble together in the summary, according to a deterministic set of rules. It has however remained a challenge to automatically generate a summary out of these deterministically selected and simplified sentences, and get a result that in fact summarizes the group of documents in a logical, accurate, and orderly structured manner.

The discussion above is merely provided for general background information and is not intended to be used as an aid in determining the scope of the claimed subject matter.

### SUMMARY

A new system is hereby provided that generates automatic summaries of groups of multiple documents using multiple variations of each sentence from a selected group of representative sentences from the documents, and then selecting from the multiple variations when assembling the automatic summary. For example, an illustrative embodiment may include steps of generating alternative strings of text, selecting from among the alternative strings of text, and providing a summary of the group of documents using the strings of text selected from among the alternatives. The alternative strings of text may be generated based on each of a plurality of sentences from the group of documents. Selecting from among the alternative strings of text may be based on one or more criteria indicating the strings of text to be representative of the content of the group of documents.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 depicts a flowchart for a method according to an illustrative embodiment.

FIG. 2 depicts a schematic representation of a system according to an illustrative embodiment.

FIG. 3 depicts a screenshot of a user application according to an illustrative embodiment.

FIG. 4 depicts a computing system environment according to an illustrative embodiment.

### DETAILED DESCRIPTION

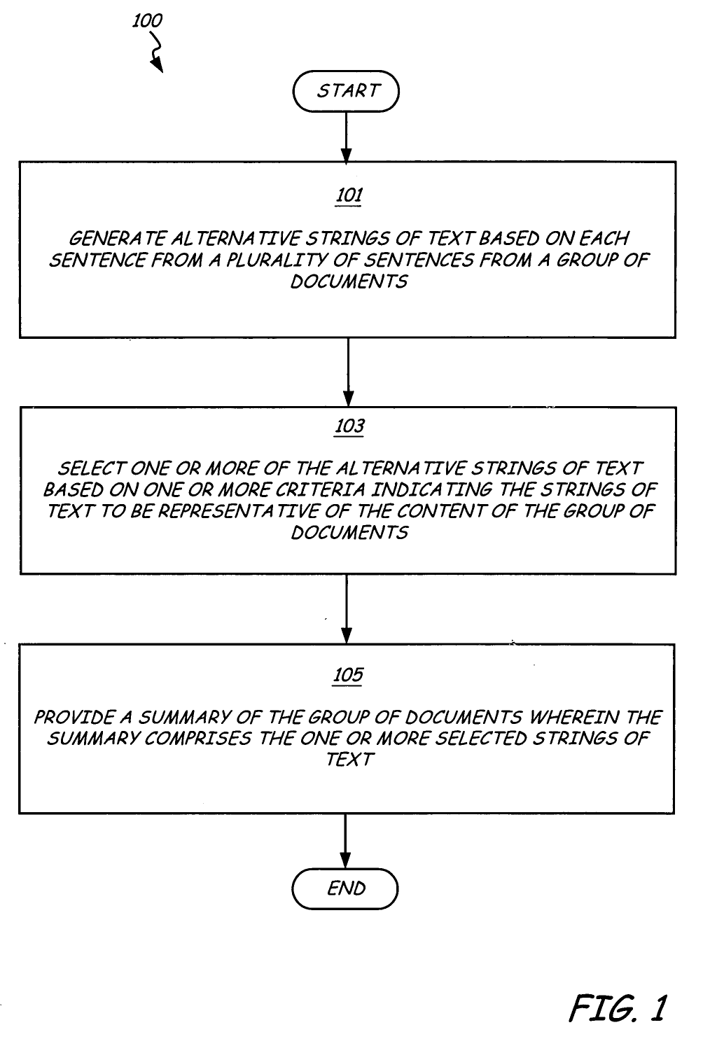

FIG. 1 depicts a block diagram of a summarization method 100 that may be implemented by a computing device to summarize collections of documents, according to an illustrative embodiment. Summarization method 100 may be illustrative of embodiments that include computing systems, and executable instructions configured to be executable by computing systems, and contexts that enable method embodiments, for example. The following discussion provides further details of various illustrative embodiments. While certain illustrative systems, methods, and computing device implementations are described in this and the subsequent figures, they are intended not to indicate any limitations, but rather to provide an illustrative example of the variety and broader meaning encompassed by the claims provided below.

Summarization method 100 includes step 101, of generating alternative strings of text based on each sentence from a plurality of sentences from a group of documents; step 103, of selecting one or more of the alternative strings of text based on one or more criteria indicating the strings of text to be representative of the content of the group of documents; and step 105, of providing a summary of the group of documents wherein the summary comprises the one or more selected strings of text. These steps are elaborated in some additional detail below. The steps of this illustrative embodiment are representative and not exclusive, and other embodiments may include other steps or aspects of or variations on these steps.

Associated with step 101, a group of documents is first provided, and a plurality of sentences are selected from the documents. The group of documents may include, for example, text files, news articles, books, web pages, emails, blog posts, research articles, or any other type of documents. In one example of method 100, a user may explicitly select a group of documents to be collectively summarized. In another example, a software system may be programmed to automatically summarize a group of documents meeting pre-indicated criteria, whether at regular intervals or on irregular occasions, for example. For example, in various illustrative embodiments, a software agent may collect a group of documents such as all the articles in the proceedings of a conference, or a research article and all of its cited references, or all the comments to a blog post, or all the emails in an inbox within a certain date range and with a specified string of text in the subject or body, or all the news articles that contain a few keywords within a given date range. These are just a few illustrative examples of groups of documents that may be collected and acted upon to generate an automatic summary of the overall content of the collected documents.

Step 101 includes generating alternative strings of text based on each sentence from a plurality of sentences from a group of documents. That is, the plurality of sentences used may include a very small number of sentences selected out from among the documents, or may include all the sentences in all the documents in the group, or any other combination of some or all of the sentences found in the collected documents.

However many sentences from the documents are used, each of the selected sentences may then be used as the basis for generating one or more alternative strings of text, based on the original sentence. These alternative strings of text may include sentences, sentence fragments, clauses, phrases, words, or any other fragments selected or paraphrased from the original sentences. The variety of different strings of text based on the original sentences provides a greater variety of forms of the original content from which to choose, in subsequently selecting strings of text that are representative of the content and that may be included in the automatic summary. This may provide content for the summary that is more valuable and useful in summarizing the documents than if the summary content was selected straight from the original content, or from single forms of modification of the sentences from the original format.

For example, a variety of different fragments may be extracted from one of the selected sentences. These fragments may include different clauses, phrases, and other sections of the sentence, including different fragments that may overlap with each other in the original sentence. Each of these fragments may then serve as an alternative string of text, and may also be used as a basis from which a variety of alternative strings of text are generated. Additional alternative strings of text may be generated from the selected sentence by parsing the original sentence, rearranging portions of the sentence, changing grammatical forms of words as appropriate, and making other changes that remain semantically consistent with the sentence, i.e. that remain consistent with the original meaning of the sentence. This may also include examples such as syntax-based simplification, which includes syntactically consistent rearrangements of fragments of the original sentences, and elimination of selected fragments. This may involve, after the original sentences have been parsed, eliminating nodes from a parse tree that represents the original sentence, where the nodes correspond to previously determined patterns for potential peripheral relevance. Parse tree nodes may be analyzed and assigned parse labels that may correspond generally to fragments of potentially low relevance, such as noun appositives, gerundive clauses, or non-restrictive relative clauses, for example.

Additional examples may include rearranging fragments of the original sentences according to their logical forms; or rearranging fragments of the original sentences consistently with paraphrasing the original sentence, such as with a parse engine or a paraphrase engine. As another example, generating the alternative strings of text may include removing portions of the original sentence based on criteria that indicate those portions to be peripheral to the content of the group of documents.

As yet another example, the group of documents to be summarized may include documents in a variety of languages, and generating the alternative strings of text may include either translating the documents prior to generating the alternative strings of text, or first generating the alternative strings of text in the original languages, then translating the selected strings of text into the target language for the summary, prior to assembling and providing the summary. Any combination of mechanisms such as these may be used to generate alternative strings of text from the original sentences, and making those alternative strings of text available to be subsequently selected from for inclusion in the summary, as method 100 passes into steps 103 and 105.

As a particular example of step 101, a group of documents to be summarized may include a document that contains the sentence, “In 1666, the English mathematician Isaac Newton theorized that the same force of gravity that causes an apple to fall to the ground, might also extend out from the Earth, diminishing with the inverse square of the distance, and govern the motion of the Moon in its orbit around the Earth.” Various different alternative strings of text may be generated based on this sentence, by different choices of words and clauses to remove or simplify, by different grammatical changes, by removing fragments indicated to be of peripheral relevance, and so forth. One such generated string of text may read, “The English mathematician Isaac Newton theorized that the same force of gravity that causes an apple to fall, might also extend out from the Earth, diminishing with the inverse square of the distance, and govern the motion of the Moon.” Another may read, “In 1666, the English mathematician Isaac Newton theorized that the same force of gravity that causes an apple to fall to the ground, might also govern the motion of the Moon in its orbit around the Earth.” Yet another may read, “Isaac Newton theorized that the force of gravity diminishes with the inverse square of distance.” Yet another alternative string of text may be generated with a paraphrasing engine, which may generate a new sentence with paraphrased components that are based on but do not explicitly appear in the original sentence, such as “Newton discovered that the law of gravity governs the motion of the moon”. Each of these alternative strings of text may subsequently be made available to select from in assembling the summary.

In the third exemplary string of text above, a grammatical change is illustratively made in addition to some words being removed. In particular, the word “diminishing” is changed to “diminishes”, in order to make it grammatically consistent with a string of text otherwise produced by removing and rearranging selected words from the original sentence. This is further illustrative of some of the variety of ways in which strings of text may be generated based on sentences from the documents. This variety of different formats of conveying different information, in a variety of ways, from the original sentence, may provide a broad basis of options from which to select the most relevant and concise content for subsequent inclusion in the summary.

A variety of strings of text may be generated in ways such as these for each sentence from among a selected group of several sentences from the group of documents. As in step 103, the various strings of text thus provided may be subjected to one or more criteria indicating the strings of text to be representative of the content of the group of documents, by whatever means such criteria may be devised or evaluated. The criteria applied to the strings of text therefore distinguish particular strings of text that may be particularly relevant, concise, and valuable to use in creating the summary. That is, these individual strings of text may be deemed to have particular value in helping to summarize the overall content of the entire group of documents, typically within a fairly low limit or par value for the word count or other measure of size for the summary.

For example, one criterion that may be used for evaluating the relevance, or summarization value, of a string of text, is a measure of the frequency of the words from the string in the group of documents. Those words that occur with the highest overall frequency throughout the group of documents, are likely to be central to the areas of particular relevance for the group of documents as a whole. Strings of text that include such high-frequency words may have particular value in providing indicative information on the group of documents, particularly if such a string contains more than one of such high-frequency words.

For example, in one illustrative embodiment, a score is assigned to each word in the documents in proportion to how many times each word appears in the documents. Alternately, as another example, the score for each word may depend in part on the proportion of documents in the group that contain the selected words, or how many of the different documents that word appears in, so that, for instance, additional appearances of the word within one document contribute less to the score than the first appearance of the word in each document. Then, the strings of text may be scored based on adding the scores of the words contained in the string of text, for example.

In another illustrative embodiment, a statement of a topic of interest may be available, and the words in the topic statement may be noted, and occurrences of these topic statement words in the documents may be assigned particularly high scores. Another illustrative scoring mechanism may involve evaluating a relevance score for a document as a whole, which may reflect that some documents are of particular relevance to the rest of the group of documents as a whole. The scores for the individual words, or for the strings of text in which they are contained, may be evaluated in part by the scores of the document or documents in which they are found. As another example, the words may be scored at least in part based on where they occur within an individual document. For example, words that occur in the titles of documents may be assigned a particularly high score or rank. Words that occur in section headings within a document, or near the beginning and end of a document, may also be assigned a particular weight. The documents themselves may often include an abstract, which may be easily, automatically identified as such, and words that occur in the abstracts of the individual documents may be accorded particular weight or high relevance score, for example.

Other variations on the criterion of word frequency may also be valuable. For example, frequency of pairs or other ordered sets of words in the documents may also be evaluated as an important criterion for summarization value, as determined by various parsing and preprocessing performed on the documents. This may be particularly useful where the documents are first parsed and certain ordered sets of words are recognized as having a particular meaning together, such as in a noun phrase.

In yet another example, the words or combinations of words may be filtered based on what kinds of words they are, such as to screen out candidate words or sets of words known to be particularly common in general usage, and therefore probably of limited value in summarizing the group of documents. This would apply especially to such common words as “the”, “of”, “a”, and so forth. In another variation, words and word sets may also be reverse filtered to screen in words or word sets that have particular intrinsic indicators of summarization value. These indicators of likely value may include rarity in general usage, for example, or extragrammatical capitalization, as another example. These are merely illustrative examples, and any other mechanisms may also be used for evaluation criteria in selecting out strings of text that may be particularly valuable in summarizing a group of documents. Another criterion, that may work in tandem with other criteria, is the length of a given string of text, as a basis of comparison for words with positive summarization value, so that the ratio or concentration of summarization value per word of a string of text is considered, rather than the gross summarization values of the words alone.

Yet another criterion for selecting strings of text for the summary may include using a classifier to distinguish content that is highly relevant to the group of documents as a whole, from content that is relatively peripheral to the overall themes of the group of documents. A machine learning classifier may be used to classify the group of documents, defining a class for the content of the group of documents in general. Strings of text may then be compared with this class, and evaluated for whether they conform to the class or constitute outliers to it. Outlying strings of text may then be omitted from the summary, in this illustrative embodiment.

Going back to the example above of the generated strings of text, the group of documents to be summarized may be about physics, and a string of text generated based on the original sentence that focuses on the physics content of the original sentence may have a particular summarization value. For example, this may be true of the string listed above that reads, “Isaac Newton theorized that the force of gravity diminishes with the inverse square of distance”. The overall group of documents may have a high frequency of occurrences of the word “gravity”, the noun phrase “force of gravity”, the word “theorized” or different words based on the word “theory”, or the noun phrase “inverse square”, for example, and the collection of a number of these frequent, high-scoring words or phrases in this one string of text may give this string of text a particularly high priority for inclusion in the summary, according to the criteria used for this illustrative embodiment.

In another example, the same document may be involved in a group of documents collected around a central theme involved in the history of science. In this case, a string of text generated based on the original sentence that focuses more on the historical content of the original sentence, may here have the more particular summarization value. For example, this may be true of the example string of text above that reads, “In 1666, the English mathematician Isaac Newton theorized that the same force of gravity that causes an apple to fall to the ground, might also govern the motion of the Moon in its orbit around the Earth.” In this case, the parsing or pre-processing may interpret the phrase “in 1666” as an historical reference to a particular year, and particularly a year in the seventeenth century, which may be one of frequent occurrences of references to historical dates in the collected group of historically-themed documents, and this may be used as a criterion for scoring the strings of text for generating the summary for this group of documents. On the other hand, alternative strings of text based on the original sentence that omit the phrase “in 1666” do not gain in score due to this criterion. As another criterion for the historically themed group of documents, the word “English” in the phrase “the English mathematician Isaac Newton” may be recognized as an identifier of national origin, which may be used as another indicator of significance in the context of a group of documents organized around an historical theme. The preservation of the word “English” in some of the strings of text based on the original sentence therefore serves as another factor in distinguishing between strings that contain more of the relevant information from the original sentence in relation to the particular group of documents to be summarized.

In each of these cases, the given string of text may score higher than any of the other strings of text generated based on that same original sentence, and higher than the original sentence itself, in the particular criteria at work for the separate groups of documents. The variety of strings generated based on the one original sentence therefore laid the groundwork for more valuable contributions to a group summary than would have been the case either with the original sentence alone, or with a single, one-size-fits-all prescriptive shortening or simplification of the original sentence.

Having the variety of strings of text based on each individual sentence from among several sentences from the group of documents, therefore, enables automatic summarizations that may provide more and more concentrated relevant information about the overall content of the group of documents, within a single summary of the combined group, within a limited size for the summary.

This leads to step 105, of providing a summary of the group of documents wherein the summary comprises the one or more selected strings of text. From among the alternative strings of text that are selected for having particularly high summarization value with respect to the group of documents, step 105 involves assembling some or all of those selected strings of text into a summary.

This conglomeration into the summary may include a variety of factors. One is size of the summary, which may be described in terms of word count, for instance. A summary may be intended to be just a few words, or up to hundreds of words, or thousands, or may be any number suitable for a summary in a particular context. As one example, one well-known conference includes instructions for each of its speakers to provide a summary of their work in only seven words. In other cases, especially for more involved collections of works, such as a comprehensive review of a broad area of interest, an appropriate summary length may run to thousands of pages or more. In still other examples, summaries in the range of 100 to 500 words are appropriate, and may for example be intended to run close to 250 words, in another illustrative example. In yet other examples, the summary may be intended to assume a particular size range in terms other than word count, such as sentence count or page count, for example. Furthermore, different definitions of word count and accepted methods of figuring word count are commonly used within specific publishing or other text handling contexts, and may further define or constrain the intended size to which the summary is to be compiled. Whatever the case, the summary may be provided with a word count in a pre-selected range, according to the requirements or specifications of different embodiments.

Besides the constraint of size, the summary often may be intended to take form according to one or more constraints or criteria for how well the summary as a whole summarizes the content of the collection of documents. This may give rise to criteria for assembling the summary such that it draws on a relatively broad, varied, complementary sampling of the selected high-relevance strings of text. For example, in one illustrative embodiment, the selected high-relevance strings of text may initially be ranked according to criteria indicating the relevance of each of them to the group of documents. Then, the one string of text ranked with the highest relevance may be the first selected to be included in the summary. Then, the content that is described or indicated in the string of text chosen for the summary may be noted, and the remaining high-relevance strings of text may be re-ranked with a lower priority assigned to the content already described by the string of text already chosen for the summary. For example, they may be re-ranked by having their scores multiplied by a re-weighting factor between 0 and 1; or, in an example in which the scores are originally calculated in terms of a number between 0 and 1, the scores may be re-ranked by applying an exponent greater than 1, such as by squaring the scores, rendering a new, lower score, in this example.

So, other strings of text that are generally high-relevance but that include content very similar to the content of the string of text already chosen for the summary, are re-scored to a significantly lower priority for inclusion in the summary. This may include lowering the scores for additional strings of text that were generated from the same original sentence as the string of text selected for the summary, which may share several words in content with that chosen string. Meanwhile, other high-relevance strings of text that have little or no overlap with the content of the material already chosen for inclusion in the summary will have little or no decrease in their priority for inclusion, and may attain a higher relative ranking compared with strings of text are re-scored downward due to duplicate content.

In this manner, the automatic summarizing system may inhibit the summary from being filled with redundant content, and instead, promote an appropriately broad survey of the content of the group of documents to be included in the summary, in this illustrative embodiment. The system may then iteratively repeat the steps of selecting the next highest-scoring string of text to include in the summary, then re-scoring the remaining candidate strings of text to avoid duplication of the content in the selected candidate string, iteratively until the intended size for the summary is achieved, in this illustrative embodiment.

In different embodiments, the above steps also may not be completely separate, and new strings of text based on the original sentences of the documents may be generated after strings of text have begun to be selected for the summary, and generated in a way that takes into account the content already present in the partially assembled summary. Duplicate content may then be avoided as part of the process of generating the alternative strings of text, together with or in place of generating the alternative strings of text, prior to beginning selecting from among those alternative strings of text for inclusion in the summary.

Once all strings of text have been settled on for the summary, the strings may be included in the order in which they were selected, or additional mechanisms may be used to rearrange the content of the selected candidate strings to combine related content into new sentences where possible, to arrange the strings into a logical order for the summary, and so forth. As one example, where the strings of text refer to dates or times, the summary may be arranged so that the strings of text are arranged into an order that corresponds to a chronological ordering of the dates or times referred to by the different strings, in one illustrative embodiment. Other mechanisms may also be used for post-selection ordering of the summary content.

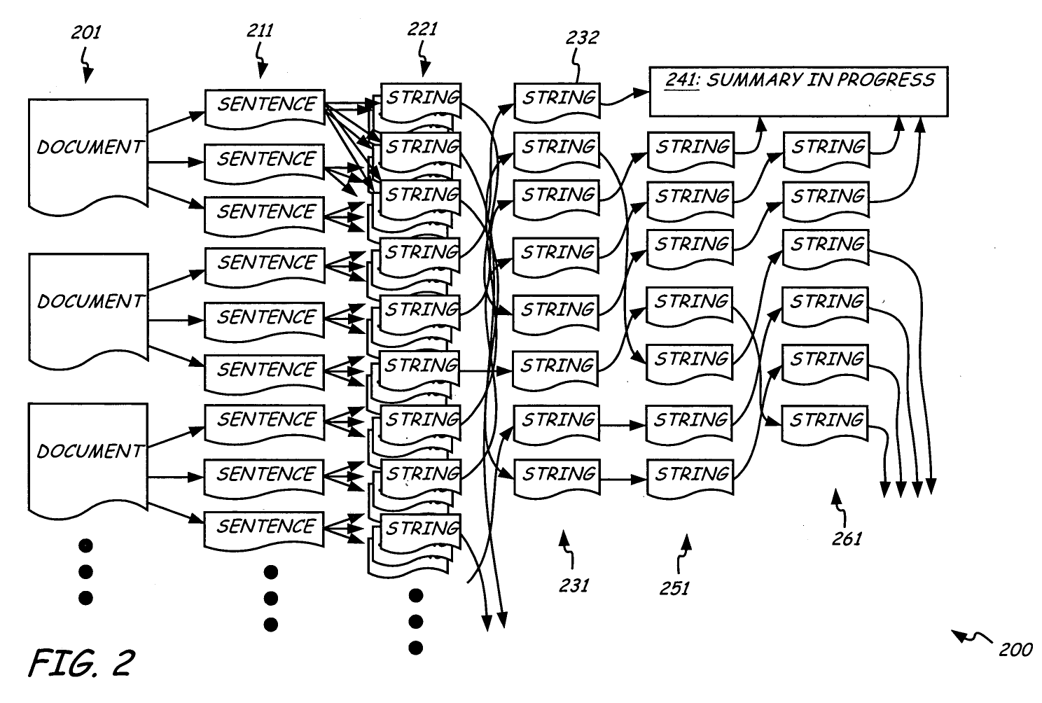

FIG. 2 depicts an abstract schematic diagram for a system 200 representing an illustrative embodiment of the method 100 of FIG. 1. In system 200, an initial collection of documents 201 is provided; a triple dot is represented for documents 201, and elsewhere in the schematic, to indicate that the explicitly depicted examples of the group are representative only of an indeterminate number of elements, in this case documents, in the group. A number of sentences 211 may be selected from these documents 201, which may include any combination, or all, of the sentences in documents 201. Once the group of sentences 211 is provided, any number or combination of mechanisms can be used to generate simplifications, fragments, rearrangements, paraphrases, copies of the original sentences in their original form, and other content based on the original sentences 211, constituting a number of alternative strings of text 221. This corresponds to step 101 in FIG. 1.

Once the collection of different strings of text 221 is provided, a narrower selection of the alternative strings of text 221 may be chosen, based on any sort or combination of criteria that indicate this narrowed group 231 of candidate strings of text to be representative of the content of the group of documents 201. This corresponds to step 103 of FIG. 1. This filtered group of high-relevance strings 231 may be ranked according to relevance scores, and their positioning within group 231 as depicted in FIG. 2, from top to bottom, may be interpreted as corresponding to their score ranking. As described above, this candidate group may include strings of text that end up having a higher relevance for the summary than any of the original sentences had, or that might have been subject to prediction in generating a single simplified version of each of the sentences beforehand. This wide variety of different strings encapsulating different versions and aspects of the original content, therefore enables a potentially far richer and more relevant summary ultimately to be produced, than is possible without using multiple alternative strings of text based on each of the selected original sentences.

Then, the string with the highest relevance score, represented by uppermost string 232, from among the group of candidates 231, may be selected for inclusion in a summary in progress 241 of the group of documents, as is depicted for string 232. The remaining strings within the candidate pool 231 may then be re-scored under new criteria altered to lower the indication of relevance for words already incorporated into summary 241 in string 232. This is depicted in the reference arrows leading from the strings in group 231 to the strings in group 251; the second-highest relevant string from group 231 is taken to have included significantly overlapping content with string 232, and is thus re-scored to a lower ranking among the strings, in the ordering of the re-ranked group of strings 251.

This process, which corresponds to step 105 in FIG. 1, is then reiterated, with the highest string from group 251 incorporated into summary 241, and the remaining strings then re-scored again in light of the additional content that is now accounted for in summary 241, causing the previously fourth-ranked string to be dropped in the rankings, and the ranks of the other strings being revised upward accordingly. In this simplified schematic, this process is taken to be reiterated to include two more strings in the next highest rank ordering from group of strings 261, and then the desired size for the summary 241 is depicted as being achieved, resulting in the remaining strings from the candidate pool being discarded. This illustrative embodiment depicts one potential example of the workings of an automatic group summarization system, although a wide variety of variations and other embodiments may also be used, and this illustrative embodiment implies no particular restrictions on the elements of other embodiments.

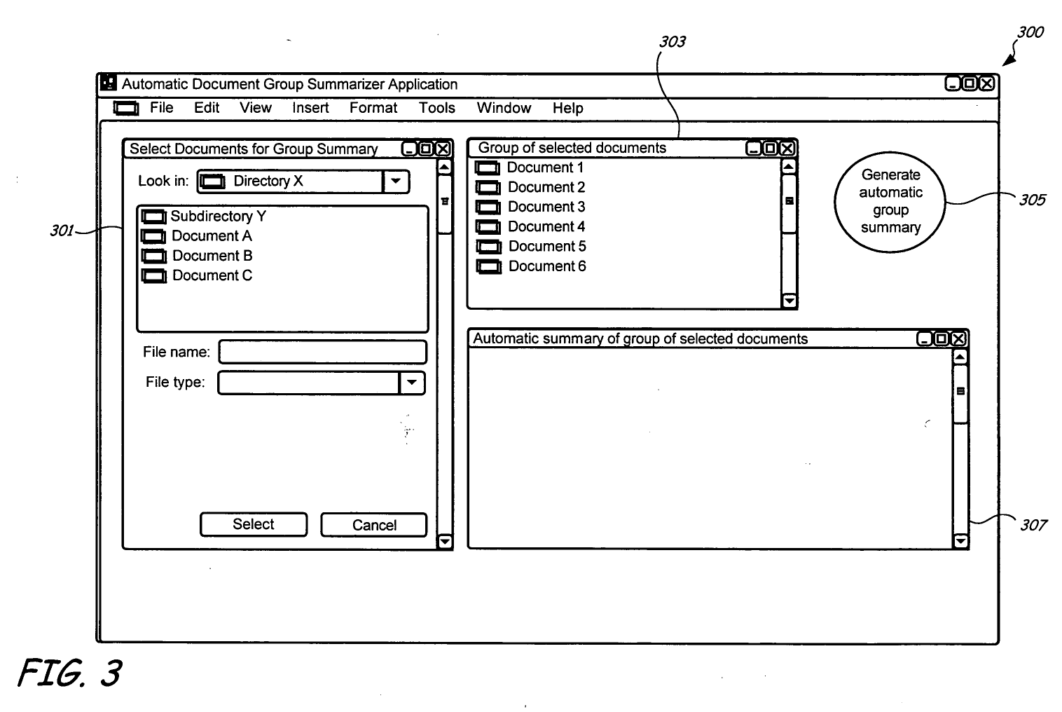

FIG. 3 depicts a screenshot 300 for a user application that enables a user to select a group of documents and have a summary of the group automatically generated, according to one illustrative embodiment. Panel 301 enables a user to select documents to be included in a group to be summarized together, which are listed in panel 303. Once a user has settled on a group of documents to be summarized, she may select button 305, such as by clicking it with a mouse or a stylus, or other user input method. Selection of the button 305 triggers the process of automatic group summary generating, which may illustratively take a form such as those indicated for method 100 of FIG. 1 and/or system 200 of FIG. 2, so that a group summary is automatically generated for the selected group of documents. The summary thus generated may be depicted for the user in panel 307, or provided by any other mode of user output. Other embodiments may simply work in the background, once set up, to regularly, automatically generate group summaries of documents accessible over the Internet or other networks, for example, before serially providing the group summaries to the user, which may be in the form of an on-screen panel in a desktop application, an email, an instant message, or any other user-accessible output mode. While the illustrative embodiment of FIG. 3 depicts aspects of one particular example of an automatic generating system, it implies no limitations on the mechanisms and aspects of the wide variety of other embodiments.

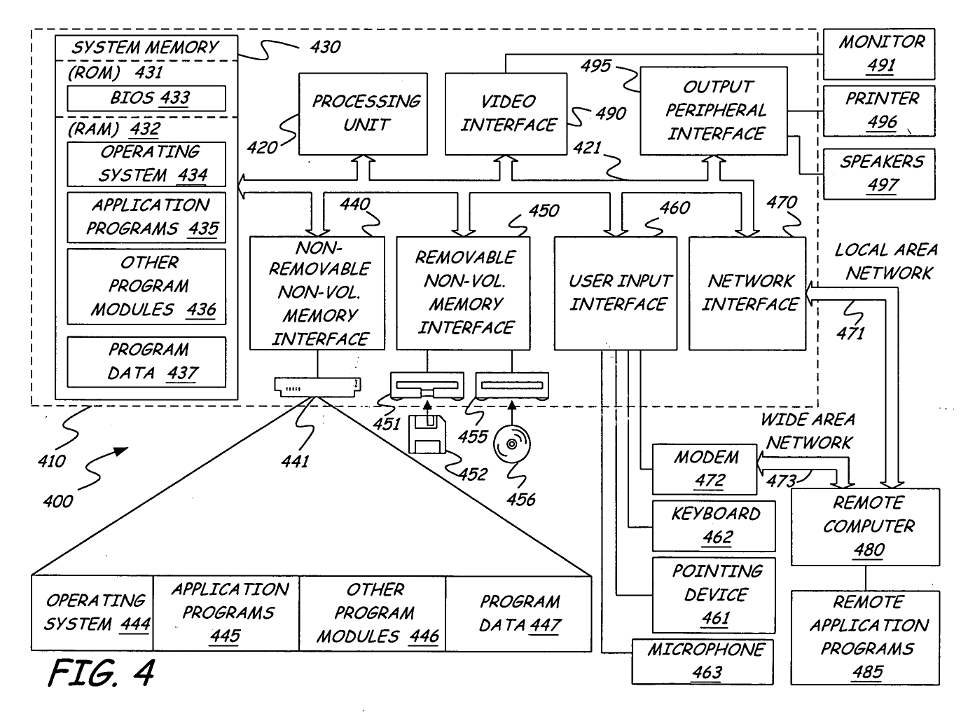

FIG. 4 illustrates an example of a suitable computing system environment 400 on which various embodiments may be implemented. For example, various embodiments may be implemented as software applications, modules, or other forms of instructions that are executable by computing system environment 400 and that configure computing system environment 400 to perform various tasks or methods involved in different embodiments. A software application or module embodying an embodiment of an automatic document group summarization system using multiple derivative generation, may be developed in any of a variety of programming or scripting languages or environments. For example, it may be written in C#, F#, C++, C, Pascal, Visual Basic, Java, JavaScript, Delphi, Eiffel, Nemerle, Perl, PHP, Python, Ruby, Visual FoxPro, Lua, or any other programming language. It is also envisioned that new programming languages and other forms of creating executable instructions will continue to be developed, in which further embodiments may readily be developed.

According to one illustrative embodiment, computing system environment 400 may be configured to perform automatic document group summarization tasks. Computing system environment 400 as depicted in FIG. 4 is only one example of a suitable computing environment for executing and providing output from various embodiments, and is not intended to suggest any limitation as to the scope of use or functionality of the claimed subject matter. Neither should the computing environment 400 be interpreted as having any dependency or requirement relating to any one or combination of components illustrated in the exemplary operating environment 400.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices. As described herein, such executable instructions may be stored on a medium such that they are capable of being read and executed by one or more components of a computing system, thereby configuring the computing system with new capabilities.

With reference to FIG. 4, an exemplary system for implementing some embodiments includes a general-purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. Application programs 435, 445, other program modules 436, 446, program data 437, 447, and other aspects of the configuration of computer 410 may include applications, executable instructions, program modules, data, and other components involved in configuring the computing system environment 400 to perform automatic document group summarization, such as is described above according to various embodiments.

A user may enter commands and information into the computer 410 through input devices such as a keyboard 462, a microphone 463, and a pointing device 461, such as a mouse, trackball or touch pad. Other input devices (not shown) may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 is operated in a networked environment using logical connections to one or more remote computers, such as a remote computer 480. The remote computer 480 may be a personal computer, a hand-held device, a server, a router, a network PC, a peer device or other common network node, and typically includes many or all of the elements described above relative to the computer 410. The logical connections depicted in FIG. 4 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on remote computer 480. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. As a particular example, while the terms “computer”, “computing device”, or “computing system” may herein sometimes be used alone for convenience, it is well understood that each of these could refer to any computing device, computing system, computing environment, mobile device, or other information processing component or context, and is not limited to any individual interpretation. As another particular example, while many embodiments are presented with illustrative elements that are widely familiar at the time of filing the patent application, it is envisioned that many new innovations in computing technology will affect elements of different embodiments, in such aspects as user interfaces, user input methods, computing environments, and computing methods, and that the elements defined by the claims may be embodied according to these and other innovative advances while still remaining consistent with and encompassed by the elements defined by the claims herein.

What is claimed is:

1. A method, implemented at least in part by a computing device, comprising:
generating a plurality of alternative strings of text based on each sentence from a plurality of sentences from a group of documents;
selecting one or more of the alternative strings of text based on one or more criteria indicating the strings of text to be representative of the content of the group of documents; and
providing a summary of the group of documents wherein the summary comprises the one or more selected strings of text.

2. The method of claim 1, wherein generating the alternative strings of text comprises selecting fragments of the sentences from the group of documents.

3. The method of claim 1, wherein generating the alternative strings of text comprises generating new strings of text based on the sentences from the group of documents.

4. The method of claim 3, wherein generating the new strings of text comprises parsing the sentences from the group of documents and generating new strings of text that are semantically consistent with the parsed sentences.

5. The method of claim 3, wherein generating the new strings of text comprises paraphrasing the sentences from the group of documents.

6. The method of claim 1, wherein generating the alternative strings of text comprises selecting sentences from the group of documents and removing portions of the sentences based on one or more criteria indicating the portions to be peripheral to the content of the group of documents.

7. The method of claim 1, wherein at least one of the documents is not in a target language in which the summary is to be provided, wherein the method further comprises translating one or more of the documents into the target language prior to generating the alternative strings of text.

8. The method of claim 1, wherein at least one of the documents is not in a target language in which the summary is to be provided, wherein the method further comprises translating the selected strings of text into the target language prior to providing the summary.

9. The method of claim 1, wherein the one or more criteria indicating the strings of text to be representative of the content of the group of documents comprise a criterion based on where the sentences on which the strings of text are based are within the documents.

10. The method of claim 1, wherein the one or more criteria indicating the strings of text to be representative of the content of the group of documents comprise a criterion based on the kinds of words contained in the strings of text.

11. The method of claim 1, wherein the one or more criteria indicating the strings of text to be representative of the content of the group of documents comprise a criterion based on the frequency with which selected words in the strings of text appear in the group of documents.

12. The method of claim 11, wherein the criterion is further based on both the frequency of the selected words in the documents individually, and the proportion of documents in the group that contain the selected words.

13. The method of claim 1, further comprising classifying the group of documents, and omitting from the summary any strings of text from documents from the group that are indicated to be outside a class defined by the classification of the group of documents.

14. The method of claim 1, wherein the summary is provided with a word count in a pre-selected range.

15. The method of claim 1, wherein providing the summary comprises generating new sentences for the summary based on the selected strings of text.

16. A medium, readable by a computing device and comprising instructions that can be executed by the computing device which configure the computing device to:
generate a plurality of alternative candidate sentences based on each of one or more sentences from a group of documents;
select one or more of the candidate sentences that are representative of the content of the group of documents; and
provide a summary of the group of documents comprising the one or more selected candidate sentences.

17. The medium of claim 16, further comprising instructions that configure the computing device such that generating the plurality of alternative candidate sentences comprises performing syntax-based simplification of the one or more sentences from the group of documents.

18. The medium of claim 16, further comprising instructions that configure the computing device such that generating the plurality of alternative candidate sentences comprises performing logical-form-based simplification of the one or more sentences from the group of documents.

19. The medium of claim 16, further comprising instructions that configure the computing device such that generating the plurality of alternative candidate sentences comprises performing paraphrasing simplification of the one or more sentences from the group of documents.

20. A computing device comprising:
means for generating candidate sentences based on content from a group of documents;
means for selecting one or more of the candidate sentences that are representative of the content of the group of documents; and
means for providing a summary of the group of documents comprising the one or more selected candidate sentences.
